(19) United States
(12) Patent Application Publication
(10) Pub. No.: US 2026/0270520 A1
(43) Pub. Date: Sep. 10, 2026

(54) DYNAMIC COMMENT DISPLAY METHOD AND APPARATUS

(71) Applicant: BEIJING ZITIAO NETWORK TECHNOLOGY CO., LTD., Beijing (CN)

(72) Inventors: Yijie LI, Beijing (CN); Angxiang FANG, Beijing (CN); Wen ZHANG, Beijing (CN); Fei ZHAO, Beijing (CN)

(21) Appl. No.: 18/875,638

(22) PCT Filed: Aug. 22, 2023
(86) PCT No.: PCT/CN2023/114197

§ 371 Date: Dec. 16, 2024

(30) Foreign Application Priority Data
Aug. 22, 2022 (CN) 202211008868.7

(51) Int. Cl. H04N 21/4788; H04N 21/431

(52) U.S. Cl. CPC H04N 21/4788; H04N 21/4312

(57) ABSTRACT

The present disclosure provides a method and apparatus for displaying dynamic comment, which belongs to the field of computer technology. The method includes: determining a first dynamic comment to be displayed in a dynamic comment display area; matching a first trajectory with the first dynamic comment; wherein the dynamic comment display area includes multiple trajectories for limiting the moving tracks of the dynamic comments, and the multiple trajectories for limiting the moving tracks of the dynamic comments include the first trajectory, each trajectory starting from the center of the dynamic comment display area, radiating outward, and extending to the edge of the dynamic comment display area; and displaying the first dynamic comment moving along the first trajectory.

### CROSS-REFERENCE TO RELATED APPLICATION(S)

This application is a U.S. National Stage Application of PCT Application Serial No. PCT/CN2023/114197, filed Aug. 22, 2023, which claims the priority of Chinese Application No. 202211008868.7 filed Aug. 22, 2022, the disclosures of which are incorporated herein by reference in their entireties.

### FIELD

The present disclosure relates to the field of computer technology, and in particular to a dynamic comment display method and apparatus.

### BACKGROUND

When users are watching videos or live broadcasts, in order to increase the interest and interactivity of watching videos or live broadcasts, the user's comment subtitles will be float and move on the display interface of the video or live broadcast. Such floating and moving comment subtitles are called dynamic comment.

In the related art, the dynamic comments posted by users are generally displayed from right to left or from bottom to top at a certain speed on the display interface of the video or live broadcast. However, in the above method, the dynamic comments are displayed on the display interface in a stereotyped manner, which is easy to reduce the user's interest, thereby reducing user stickiness and poor user experience.

### SUMMARY

In view of this, the purpose of the present disclosure is to provide a dynamic comment display method and apparatus.

Based on the above purpose, the present disclosure provides a dynamic comment display method, comprising:
determining the first dynamic comment to be displayed in the dynamic comment display area;
matching a first trajectory with the first dynamic comment; wherein the dynamic comment display area includes a plurality of trajectories for defining moving tracks of dynamic comments, the plurality of trajectories for defining the moving track of the dynamic comments include the first trajectory, and each trajectory starts from a center of the dynamic comment display area, radiates outward, and extends to an edge of the dynamic comment display area; and
displaying the first dynamic comment moving along the first trajectory.

Optionally, matching a first trajectory with the first dynamic comment includes:
Obtaining a second trajectory used when displaying a second dynamic comment, the second dynamic comment being the previous dynamic comment of the first dynamic comment; and matching the first trajectory from other trajectories except the second trajectory.
Optionally, matching a first trajectory with the first dynamic comment includes:
obtaining a second trajectory used when displaying a second dynamic comment, the second dynamic comment being the previous dynamic comment of the first dynamic comment; and
matching the first trajectory from trajectories whose angle with the second trajectory is greater than a first threshold.

Optionally, matching a first trajectory with the first dynamic comment includes:
obtaining a cumulative number of usage times for each trajectory; and
matching the first trajectory from trajectories with the least cumulative number of usage times

Optionally, matching a first trajectory with the first dynamic comment includes:
obtaining a number of co-occurring dynamic comments in each trajectory, wherein the number of co-occurring dynamic comments is a number of dynamic comments currently displayed on the trajectory; and
matching the first trajectory from trajectories with the least number of co-occurring dynamic comment.

Optionally, displaying the first dynamic comment moving along the first trajectory comprises:
detecting a number of co-occurring dynamic comments in the first trajectory, wherein the number of co-occurring dynamic comments is a number of dynamic comments currently displayed on the first trajectory; and
in the case that the number of the co-occurring dynamic comments is greater than a second threshold, increasing a moving speed of the first dynamic comment.

Optionally, displaying the first dynamic comment moving along the first trajectory includes:
moving the first dynamic comment along the first trajectory, and during a process of moving the first dynamic comment, changing at least one of the following parameters of the first dynamic comment gradually: size;
transparency; and
the offset value within the trajectory.

Optionally, displaying the first dynamic comment moving along the first trajectory includes:
moving the first dynamic comment along the first trajectory;
in the case that the first dynamic comment contacts the edge of the dynamic comment display area, adjusting a moving direction of the first dynamic comment to be perpendicular to the edge of the dynamic comment display area.

Optionally, the method further comprises:
feathering upper and lower edges of the dynamic comment display area.

The present disclosure also provides a dynamic comment display apparatus, comprising:
a determination module, configured to determine a first dynamic comment to be displayed in a dynamic comment display area;
a matching module, configured to match a first trajectory with the first dynamic comment, wherein the dynamic comment display area includes a plurality of trajectories for defining moving tracks of dynamic comments, the plurality of trajectories for defining the moving tracks of the dynamic comments include the first trajectory, and each trajectory starts from a center of the dynamic comment display area, radiate outward and extend to an edge of the dynamic comment display area; and
a display control module, configured to display the first dynamic comment moving along the first trajectory.

The present disclosure also provides an electronic device, including a memory, a processor, and a computer program stored in the memory and executable on the processor, wherein the processor, when executing the program, implements the above-mentioned dynamic comment display method.

The present disclosure also provides a non-transitory computer-readable storage medium, which stores computer instructions, and the computer instructions are configured to enable a computer to execute the above-mentioned dynamic comment display method.

The present disclosure also provides a computer program product, including a computer program, which implements any of the above-mentioned dynamic comment display methods when executed by a processor.

From the above description, it can be seen that the dynamic comment display method and apparatus provided by the present invention provide a new dynamic comment track, which supports radiating outward from the center of the dynamic comment display area and extending to the edge of the dynamic comment display area, thereby increasing user interest, increasing user stickiness, and improving user experience.

### BRIEF DESCRIPTION OF THE DRAWINGS

In order to more clearly illustrate the technical solutions in the present disclosure or related technologies, the drawings required for use in the embodiments or related technical descriptions will be briefly introduced below. obviously, the drawings described below are only embodiments of the present disclosure. for ordinary technicians in this field, other drawings can be obtained based on these drawings without paying creative work.

FIG. 1 is a schematic diagram of a dynamic comment display method according to an embodiment of the present disclosure;

FIG. 2 is a schematic diagram of the dynamic comment display principle under the Android system according to an embodiment of the present disclosure;

FIG. 3 is a schematic diagram of the dynamic comment display principle under the iOS system according to an embodiment of the present disclosure;

FIG. 4 is a schematic diagram of the calculation principle of the dynamic comment moving tracks in the iOS system according to an embodiment of the present disclosure;

FIG. 5 is a schematic diagram of a dynamic comment display apparatus according to an embodiment of the present disclosure;

FIG. 6 is a schematic diagram of an electronic device according to an embodiment of the present disclosure.

### DETAILED DESCRIPTION OF EMBODIMENTS

In order to make the objectives, technical solutions and advantages of the present disclosure more clearly understood, the present disclosure is further described in detail below in combination with specific embodiments and with reference to the accompanying drawings.

It should be noted that, unless otherwise defined, the technical terms or scientific terms used in the embodiments of the present disclosure should be understood by people with ordinary skills in the field to which the present disclosure belongs. The “first”, “second” and similar words used in the embodiments of the present disclosure do not indicate any order, quantity or importance, but are only used to distinguish different components. “Include” or “comprise” and similar words mean that the elements or objects appearing before the word cover the elements or objects listed after the word and their equivalents, without excluding other elements or objects.

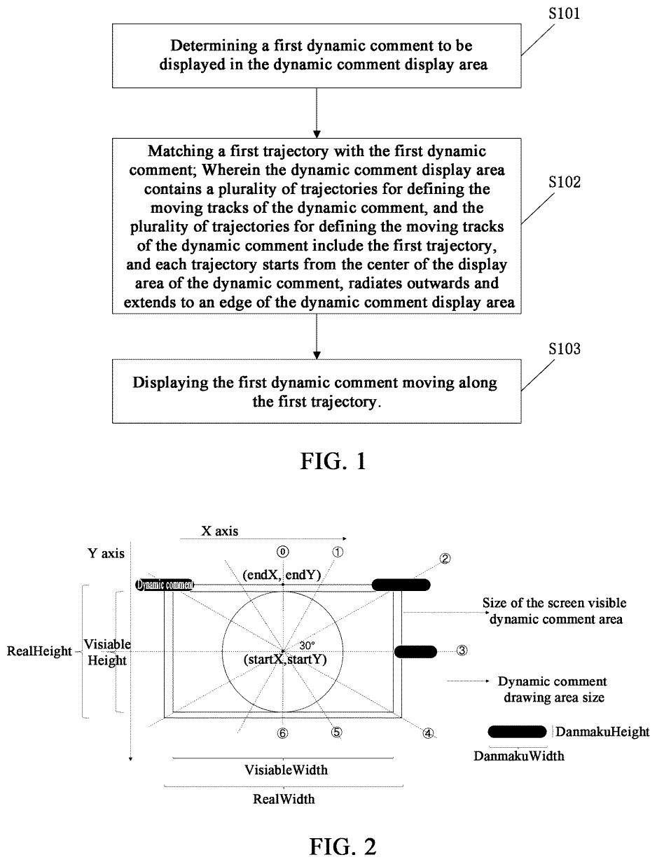

FIG. 1 is a schematic diagram of a dynamic comment display method according to an embodiment of the present disclosure. As shown in FIG. 1, an embodiment of the present disclosure provides a dynamic comment display method, the execution subject of which may be an electronic device, such as a computer, etc. The method includes:
Step 101: determining the first dynamic comment to be displayed in the dynamic comment display area;
Step 102: matching a first trajectory with the first dynamic comment; wherein the dynamic comment display area includes a plurality of trajectories for defining moving tracks of dynamic comments, the plurality of trajectories for defining the moving tracks of the dynamic comments include the first trajectory, and each trajectory starts from a center of the dynamic comment display area, radiates outward, and extends to the edge of the dynamic comment display area;
Step 103: displaying the first dynamic comment moving along the first trajectory.

Specifically, FIG. 2 is a schematic diagram of the dynamic comment display principle under the Android system of an embodiment of the present disclosure. As shown in FIG. 2, under the Android system, the dynamic comment display area includes multiple trajectories for limiting the movement tracks of the dynamic comments, and each trajectory starts from a center of the dynamic comment display area, radiates outward, and extends to the edge of the dynamic comment display area.

For example, similar to the dial of a clock, the screen is divided into 12 equal parts according to the angle, and the dividing line of each part is a trajectory. The inner box represents the size of the actual dynamic comment area on the mobile phone screen, and the outer box represents the size of the canvas for drawing the dynamic comments, because the dynamic comments need to be completely moved out of the screen to be considered moved, otherwise the audience will find that the dynamic comments suddenly disappear at the edge of the screen.

Taking FIG. 2 as an example, it can be regarded as the end of the movement only when the center of the dynamic comment moves to the boundary of the outer box. Taking FIG. 2 as an example, it is known that the dynamic comment is sent from the center of the screen area, and the starting point is (startX, startY)

Then for the end point of each trajectory, there is the following calculation formula:

### Trajectory No. 0:

$$endX 0 = startX \\ dX endY 0 = startY - RealHeight / 2 startX$$

Among them, endx0 is the horizontal coordinate of the end point of trajectory No. 0, startX is the horizontal coordinate of the center point of the dynamic comment display area, endY0 is the vertical coordinate of the end point of trajectory No. 0, startY is the horizontal coordinate of the center point of the dynamic comment display area, RealHeight is the actual height of the dynamic comment display area.

### Trajectory No. 1:

$$endX 1 = startX + ( RealHeight / 2 * tan 30 ° ) \\ endY 1 = startY - RealHeight / 2$$

Among them, endX1 is the horizontal coordinate of the end point of trajectory No. 1, startX is the horizontal coordinate of the center point of the dynamic comment display area, endY1 is the vertical coordinate of the end point of trajectory No. 1, startY the horizontal coordinate of the center point of the dynamic comment display area, and RealHeight is the actual height of the dynamic comment display area.

### Trajectory No. 2:

$$endX 2 = startX + RealHeight / ( 2 * tan 30 ° ) \\ endY 2 = startY - RealHeight / 2$$

Among them, endX2 is the horizontal coordinate of the end point of trajectory No. 2, startX is the horizontal coordinate of the center point of the dynamic comment display area, endY2 is the vertical coordinate of the end point of trajectory No. 2, startY is the horizontal coordinate of the center point of the dynamic comment display area, and RealHeight. is the actual height of the dynamic comment display area. trajectory No. 3:

$$endX 3 = startX + VisiableWidth / 2 + DanmakuWidth / 2 \\ endY 3 = startY$$

Among them, endX3 is the horizontal coordinate of the end point of trajectory No. 3, startX is the horizontal coordinate of the center point of the dynamic comment display area, VisiableWidth is the visible width of the dynamic comment display area, DanmakuWidth is the width of the dynamic comment, endY3 is the vertical coordinate of the end point of trajectory No. 3, startY is the horizontal coordinate of the center point of the dynamic comment display area.

### Trajectory No. 4:

$$endX 4 = startX + RealHeight / ( 2 * tan 30 ° ) \\ endY 4 = startY + RealHeight / 2$$

Among them, endX4 is the horizontal coordinate of the end point of trajectory No. 4, startX is the horizontal coordinate of the center point of the dynamic comment display area, endY4 is the vertical coordinate of the end point of trajectory No. 4, startY is the horizontal coordinate of the center point of the dynamic comment display area, RealHeight is the actual height of the dynamic comment display area.

### Trajectory No. 5:

$$endX 5 = startX + ( RealHeight / 2 * tan 30 ° ) \\ endY 5 = startY + RealHeight / 2$$

Among them, endX'S is the horizontal coordinate of the end point of trajectory No. 5, startX is the horizontal coordinate of the center point of the dynamic comment display area, endY5 is the vertical coordinate of the end point of trajectory No. 5, startX is the horizontal coordinate of the center point of the dynamic comment display area, RealHeight is the actual height of the dynamic comment display area.

### Trajectory No. 6:

$$endX 6 = startX \\ endY 6 = startY + RealHeight / 2$$

Among them, endX6 is the horizontal coordinate of the end point of trajectory No. 6, startX. is the horizontal coordinate of the center point of the dynamic comment display area, endY6 is the vertical coordinate of the end point of trajectory No. 6, startX is the horizontal coordinate of the center point of the dynamic comment display area, RealHeight is the actual height of the dynamic comment display area.

The calculation rules for trajectories No. 7-11 (not shown in the figures) are similar.

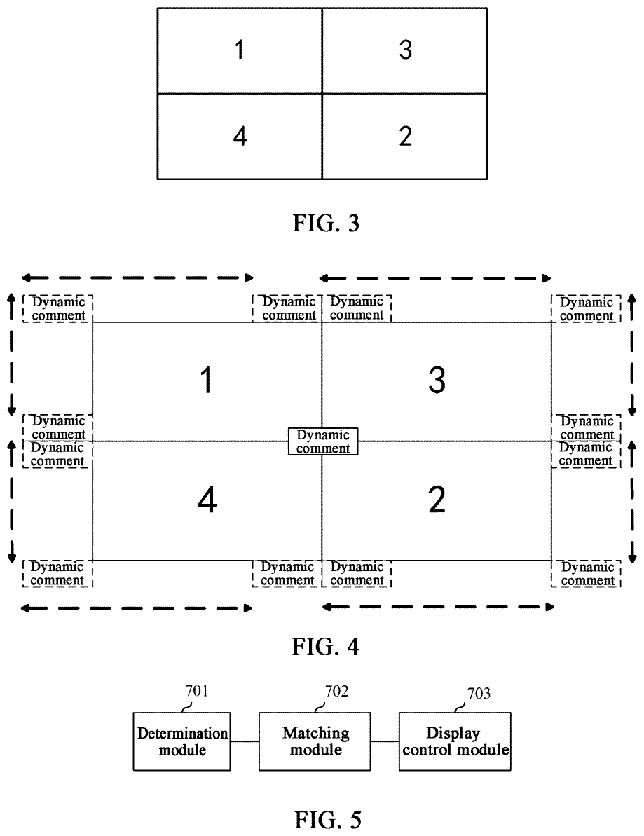

FIG. 3 is a schematic diagram of the dynamic comment display principle under the ios system of an embodiment of the present disclosure. As shown in FIG. 3, under the ios system, the dynamic comment display area includes multiple trajectories for limiting the movement tracks of the dynamic comments, and each trajectory starts from the center of the dynamic comment display area, radiates outward, and extends to the edge of the dynamic comment display area.

For example, after the size of the dynamic comment display area (dynamic comment curtain) is determined, the dynamic comment display area can be evenly divided into four sub-areas, each of which contains at least one trajectory.

Optionally, matching a first trajectory with the first dynamic comment includes:
obtaining a second trajectory used when displaying a second dynamic comment; the second dynamic comment being the previous dynamic comment of the first dynamic comment;
matching the first trajectory from other trajectories except the second trajectory.

Specifically, in order to achieve the overall effect of the dynamic comment display being divergent from the center and staggered, when matching the trajectory with the dynamic comment, two adjacent dynamic comments may not be displayed continuously using the same trajectory.

For example, in FIG. 2, if it is shown that the previous dynamic comment used trajectory No. 0, then for the current dynamic comment, a trajectory can be matched from trajectories other than trajectory No. 0.

In the ios system, priority selection control (1, 2, 3, 4) can be performed according to the sub-area number. For each sub-area, the availability control and the control of the number of dynamic comments that can be displayed at the same time are performed to ensure that the dynamic comments are evenly distributed in each sub-area.

It should be noted that: in the above scheme, under the ios system, it is only exemplary to divide the dynamic comment display area into four sub-areas numbered 1, 2, 3, and 4, and other division methods or orders may also be used, which will not be repeated here.

Every time a sub-area is used to launch dynamic comments, a delay (for example, 500 ms) is added, and the area is inaccessible before the delay expires. In this way, access to other available areas can be realized, and the purpose of uniform distribution of areas can be achieved.

Optionally, matching a first trajectory with the first dynamic comment includes:
Obtain a second trajectory used when displaying a second dynamic comment; the second dynamic comment being the previous dynamic comment of the first dynamic comment;
matching the first trajectory from trajectories whose angle with the second trajectory is greater than a first threshold. Specifically, in order to achieve the overall effect that the dynamic comment display being divergent from the center and staggered. When matching trajectories for dynamic comments, two adjacent dynamic comments may not be displayed using adjacent trajectories, that is, the angle between the two trajectories is greater than a certain threshold.

For example, in FIG. 2, if the previous dynamic comment was displayed using trajectory No. 0, then for the current dynamic comment, a trajectory can be matched from trajectories No. 5, 6, and 7. The angle between trajectories No. 5, 6, and 7 and trajectory No. 0 is greater than 120 degrees, thereby achieving an overall effect of the dynamic comment display being divergent from the center and staggered.

In the ios system, priority selection control (1, 2, 3, 4) can be performed according to the sub-area number. For each sub-area, the availability control and the control of the number of dynamic comments that can be presented at the same time are performed to ensure that the dynamic comments are evenly distributed in each sub-area.

According to the position characteristics of the four areas, they are divided into whether they are in the left area and whether they are in the top area, and are filled into the array one by one according to the preset order. For example, as shown in FIG. 3, after the dynamic comment display area is divided into four sub-areas, any sub-area is selected to generate a dynamic comment, the next (second) dynamic comment is generated by selecting the sub-area at the diagonal position, the next (third) dynamic comment is generated by selecting the adjacent sub-area, and the next (fourth) dynamic comment is generated by selecting the area at the diagonal position.

Optionally, matching a first trajectory with the first dynamic comment includes: obtaining a cumulative number of usage times for each trajectory;
matching the first trajectory from trajectories with the least cumulative number of usage times.

Optionally, matching a first trajectory with the first dynamic comment includes:
obtaining a number of co-occurring dynamic comments in each trajectory, wherein the number of co-occurring dynamic comments is a number of dynamic comments currently displayed on the trajectory;
matching the first trajectory from trajectories with the least number of co-occurring dynamic comments.

Specifically, to prevent the extreme effect of dynamic comment stacking in a sub-area (corresponding to one or more trajectories), each time a dynamic comment is associated with a sub-area, the current dynamic comment counter of the sub-area is increased, and is decreased after the dynamic comment is completed.

When matching trajectories, you can match trajectories from the trajectories with the least cumulative usage times, or you can match trajectories from the trajectories with the least number of co-occurring dynamic comments.

When the counter reaches a threshold (for example, it can be set to 6), the sub-area will also be inaccessible, so as to achieve the purpose of uniform distribution of the dynamic comments.

Under the ios system, by controlling the calculation of the moving tracks of the dynamic comments, the overall effect of the dynamic comment display being divergent from the center and staggered can be achieved.

FIG. 4 is a schematic diagram of the calculation principle of the dynamic comment moving track under the ios system of the embodiment of the present disclosure. As shown in FIG. 4, in the calculation of the dynamic comment moving track, a random landing point calculation based on the selection of the dynamic comment moving area is adopted. In FIG. 4, the solid line dynamic comment is the initial position of the dynamic comment, the dotted line dynamic comment is the boundary of the possible landing point position of the dynamic comment, and the double-arrow dotted line is the random displacement range of the non-main moving axis of the corresponding area.

The specific degree of randomness is divided into two steps: the random in the display end direction, and the random in the non-display end direction displacement. For the random in the display end direction, there will be two situations when the dynamic comment moves out of the curtain (that is, the display ends). Move along the X axis until the dynamic comment is invisible; move along the Y axis until the dynamic comment is invisible. This random process is to choose one of the x and y axes.

For the random in the non-display end direction displacement, when only the main moving axis direction is selected, the dynamic comment movement track is horizontal or vertical, and it needs to move diagonally (to achieve a radiation effect), then it is necessary to offset in the non-main moving axis direction. The calculation of the offset is a comprehensive calculation based on the size of the selected area and the dynamic comment size.

In order to ensure that the landing point can cover 360°, a distinction calculation was performed by combining the fixed initial position of the dynamic comment (center of the curtain) and the position and size of the selected display area.

Simply put, the movement trajectory of the dynamic comment is the combined movement of the x and y axis directions. By controlling the movement in the x and y axis directions separately, the effect of the dynamic comment moving radially from the center point can be achieved.

Among them, after determining that either x or y is the main axis movement direction, the size of the sub-movement of the other axis does not need to be too precise. As long as a sub-movement along the other axis is set, a random radiation effect can be achieved.

Optionally, displaying the first dynamic comment moving along the first trajectory includes:
detecting a number of co-occurring dynamic comments in the first trajectory, wherein the number of co-occurring dynamic comments is a number of dynamic comments currently displayed on the first trajectory;
and

in the case that the number of the co-occurring dynamic comments is greater than a second threshold, increasing a moving speed of the first dynamic comment.

Optionally, displaying the first dynamic comment moving along the first trajectory includes:
moving the first dynamic comment along the first trajectory, and
during a process of moving the first dynamic comment, changing at least one of the following parameters of the first dynamic comment gradually:
size;
transparency; and
the offset value within the trajectory.

Specifically, when the dynamic comment moves from the starting point to the end point of each trajectory, it can also be accompanied with changes in transparency, change in size, and change in offset value within the trajectory. The change in transparency requires changing the alpha property of the Paint that draws the Bitmap. The movement and scaling of the dynamic comment are completed using matrix calculations, and matrix calculations need to be completed in the order of “rotation-scaling-translation”.

After determining the starting point (startX, startY) and end point coordinates (endX, endY) on a trajectory, and the dynamic comment needs to complete deformation and movement within n seconds, the actual position (translateX, translateY) of the dynamic comment at a certain time point, the scaling value (scaleX, scale Y) of the current dynamic comment, and the alpha value of the current dynamic comment can be calculated.

The variables at the s-th second are calculated as follows:

$$translateX = ( endX - startX ) * ( s / n ) \\ translateY = ( endY - endX ) * ( s / n ) scaleX = s / n \\ scaleY = s / nalpha = 255 * ( s / n )$$

Then finally call Androidapi to complete the drawing of the dynamic comment at the current s-th second.

Under the ios system, through the one-way stereo trajectory setting items and the center reflection trajectory setting items, the effect of gradual changes in trajectory speed, size, transparency, and offset value within the trajectory can be achieved.

The overlapping and front-to-back three-dimensional effects of dynamic comments can be achieved by setting the size, transparency, and position offset value of the dynamic comments. The specific parameter configuration is shown in Table 1.

TABLE 1
One of the parameter configuration

| dynamic | Size | | offset value within |
|---|---|---|---|
| comment style | ratio | transparency | the trajectory |
| Style 1 | 100% | 100% | 0 px |
| Style 2 | 90% | 90% | 6 px |
| Style 3 | 80% | 80% | 12 px |

For example, the size ratio of style 1 is set to 100%, the transparency is set to 100%, and the offset value within the trajectory is set to 0 px; the size ratio of style 2 is set to 90%, the transparency is set to 90%, and the offset value within the trajectory is set to 6 px; the size ratio of style 3 is set to 80%, the transparency is set to 80%, and the offset value within the trajectory is set to 12 px.

The radiation effect can also be controlled through the moving tracks and the positive change of the proportion/transparency, and the speed and density are controlled by the duration and the maximum number of co-occurring dynamic comments. The specific parameter configurations are shown in Tables 2 and 3.

TABLE 2
Parameter configuration table under Android system

| Drawing 12 central radiation trajectories evenly. | | |
|---|---|---|
| dynamic | Proportion | 0%→100%→100% |
| comment | Go through the | 0%→80%→100% |
| animation | length of trajectory | |

| | |
|---|---|
| Speed of each dynamic comment | 150 px/s |
| Density control | There are at most 3 dynamic |
| | comments in each trajectory. |

TABLE 3
Parameter configuration table under the ios system
cross-cut 4 quadrants, and the dynamic comment appears at a random end point in the quadrant.

| dynamic | Proportion | 0%→100%→100% |
|---|---|---|
| comment | Go through the length | 0%→80%→100% |
| Animation | of trajectory | |
| Speed of each dynamic comment | | 5 s to complete |
| Density control | | There are at most 6 dynamic comments in each quadrant |
| | | In the diagonal quadrants (upper left + lower right ) and (upper |
| | | right + lower left ) |
| | | The dynamic comments appear in a staggered manner, with a |
| | | staggered interval of 500 ms |

For example, within the first 80% of the path of the dynamic comment track, the size and transparency of the dynamic comment gradually increase from zero to 80%; within the last 20% of the path, the dynamic comment is displayed with full size and transparency. Optionally, displaying the first dynamic comment moving along the first trajectory comprises includes: moving the first dynamic comment along the first trajectory;

in the case that the first dynamic comment contacts the edge of the dynamic comment display area, adjusting a moving direction of the first dynamic comment to be perpendicular to the edge of the dynamic comment display area.

Specifically, when the dynamic comment moves out of the curtain (i.e. the display ends), there are two situations: moving along the X-axis until the dynamic comment is invisible; moving along the Y-axis until the dynamic comment is invisible. This random process is to select one of the x-axis and γ-axis. That is, when the dynamic comment touches the edge of the dynamic comment display area, the moving direction of the dynamic comment is adjusted to be perpendicular to the edge of the dynamic comment display area (moving along the X-axis or Y-axis), so as to achieve the overall effect of the dynamic comment being staggered.

Optionally, the method further comprises:
feathering upper and lower edges of the dynamic comment display area.

Specifically, the upper and lower edges of the dynamic comment display area are feathered to make the connection between the dynamic comment and the image softer and the physical feel more comfortable.

The dynamic comment display method provided by the present invention provides a new dynamic comment track, which supports radiating outward from the center of the dynamic comment display area and extending to the edge of the dynamic comment display area, thereby increasing user interest, increasing user stickiness, and improving user experience.

It should be noted that the method of the embodiment of the present disclosure can be performed by a single device, such as a computer or a server. The method of the present embodiment can also be applied in a distributed scenario and completed by multiple devices cooperating with each other. In the case of such a distributed scenario, one of the multiple devices can only perform one or more steps in the method of the embodiment of the present disclosure, and the multiple devices will interact with each other to complete the described method.

It should be noted that some embodiments of the present disclosure are described above. Other embodiments are within the scope of the appended claims. In some cases, the actions or steps recorded in the claims can be performed in an order different from that in the above embodiments and still achieve the desired results. In addition, the processes depicted in the accompanying drawings do not necessarily require the specific order or continuous order shown to achieve the desired results. In some embodiments, multitasking and parallel processing are also possible or may be advantageous.

Based on the same technical concept, corresponding to any of the above-mentioned embodiment methods, the present disclosure also provides a dynamic comment display apparatus.

FIG. 5 is a schematic diagram of a dynamic comment display apparatus according to an embodiment of the present disclosure. As shown in FIG. 5, the dynamic comment display apparatus includes a determination module 701, a matching module 702 and a display control module 703, wherein: the determination module 701 is configured to determine a first dynamic comment to be displayed in a dynamic comment display area;

The matching module 702 is configured to match a first trajectory for the first dynamic comment; wherein the dynamic comment display area includes a plurality of trajectories for defining a moving tracks of the dynamic comments, the plurality of trajectories for defining the moving tracks of the dynamic comments include the first trajectory, and each trajectory starts from the center of the dynamic comment display area, radiates outward, and extends to the edge of the dynamic comment display area;

The display control module 703 is configured to move and display the first dynamic comment along the first trajectory. Optionally, matching a first trajectory with the first dynamic comment includes:
obtaining a second trajectory used when displaying a second dynamic comment; the second dynamic comment is the previous dynamic comment of the first dynamic comment;
matching the first trajectory from other trajectories except the second trajectory. Optionally, matching a first trajectory with the first dynamic comment includes:
obtaining a second trajectory used when displaying a second dynamic comment; the second dynamic comment is the previous dynamic comment of the first dynamic comment;
matching the first trajectory from trajectories whose angle with the second trajectory is greater than a first threshold.

Optionally, matching a first trajectory with the first dynamic comment includes: obtaining a cumulative number of usage times each trajectory;
matching the first trajectory from trajectories with the least cumulative number of usage times.

Optionally, matching a first trajectory with the first dynamic comment includes:
obtaining a number of co-occurring dynamic comments in each trajectory, wherein the number of co-occurring dynamic comments is a number of dynamic comments currently displayed on the trajectory; and
matching the first trajectory from trajectories with the least number of co-occurring dynamic comments.

Optionally, displaying the first dynamic comment moving along the first trajectory includes:
detecting a number of co-occurring dynamic comments in the first trajectory, wherein the number of co-occurring dynamic comments is a number of dynamic comments currently displayed on the first trajectory; and
in response that the number of the co-occurring dynamic comments is greater than a second threshold, increasing a moving speed of the first dynamic comment.

Optionally, displaying the first dynamic comment moving along the first trajectory includes:
moving the first dynamic comment along the first trajectory, and during a process of moving the first dynamic comment, changing at least one of the following parameters of the first dynamic comment gradually:
size;
transparency;
The offset value within the trajectory.

Optionally, displaying the first dynamic comment moving along the first trajectory comprises: moving the first dynamic comment along the first trajectory;
in the case that the first dynamic comment contacts the edge of the dynamic comment display area, adjusting a moving direction of the first dynamic comment to be perpendicular to the edge of the dynamic comment display area. Optionally, the apparatus further includes a feathering module;

The feathering module is configured to perform feathering on the upper and lower edges of the dynamic comment display area.

For the convenience of description, the above apparatuses are described separately by functions into various modules. Of course, when implementing the present disclosure, the functions of each module can be implemented in the same or multiple software and/or hardware. The device of the above embodiment is used to implement the corresponding dynamic comment display method in any of the above embodiments, and has the beneficial effects of the corresponding method embodiment, which will not be repeated here.

Based on the same technical concept, corresponding to any of the above-mentioned embodiments, the present disclosure also provides an electronic device, including a memory, a processor, and a computer program stored in the memory and executable on the processor, wherein the processor implements the dynamic comment display method described in any of the above embodiments when executing the program.

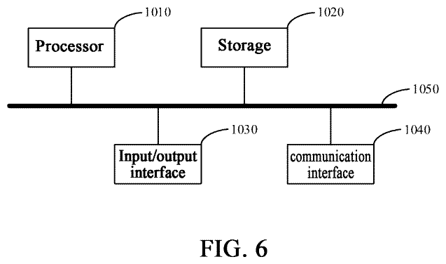

FIG. 6 shows a more specific schematic diagram of the hardware structure of an electronic device provided in this embodiment. The device may include: a processor 1010, a storage 1020, an input/output interface 1030, a communication interface 1040 and a bus 1050. The processor 1010, the storage 1020, the input/output interface 1030 and the bus 1050 are shown in FIG. 6.

15 and the communication interface 1040 realize communication connection between each other within the device through the bus 1050.

The processor 1010 can be implemented by a general-purpose CPU (Central Processing Unit), a microprocessor, an application-specific integrated circuit (ASIC), or one or more integrated circuits, etc., and is used to execute relevant programs to implement the technical solutions provided in the embodiments of this specification.

The storage 1020 may be implemented in the form of ROM (Read Only Memory), RAM (Random Access Memory), static storage device, dynamic storage device, etc. The storage 1020 may store an operating system and other application programs. When the technical solutions provided in the embodiments of this specification are implemented by software or firmware, the relevant program codes are stored in the storage 1020 and are called and executed by the processor 1010.

The input/output interface 1030 is used to connect the input/output module to realize information input and output. The input/output module can be configured as a component in the device (not shown in the figures), or it can be externally connected to the device to provide corresponding functions. The input device may include a keyboard, a mouse, a touch screen, a microphone, various sensors, etc., and the output device may include a display, a speaker, a vibrator, an indicator light, etc.

The communication interface 1040 is used to connect a communication module (not shown in the figures) to realize communication interaction between the device and other devices. The communication module can realize communication through a wired method (such as USB, network cable, etc.) or a wireless method (such as mobile network, WIFI, Bluetooth, etc.). The bus 1050 includes a channel to transmit information between various components of the device (such as the processor 1010, the storage 1020, the input/output interface 1030 and the communication interface 1040).

It should be noted that, although the above device only shows the processor 1010, the storage 1020, the input/output interface 1030, the communication interface 1040 and the bus 1050, in the specific implementation process, the device may also include other components necessary for normal operation. In addition, it can be understood by those skilled in the art that the above device may also only include the components necessary for implementing the embodiments of the present specification, and does not necessarily include all the components shown in the figures.

The electronic device of the above-mentioned embodiment is used to implement the corresponding dynamic comment display method in any of the above-mentioned embodiments, and has the beneficial effects of the corresponding method embodiment, which will not be repeated here.

Based on the same technical concept, corresponding to any of the above-mentioned embodiment methods, the present disclosure also provides a non-transitory computer-readable storage medium, wherein the non-transitory computer-readable storage medium stores computer instructions, and the computer instructions are used to enable the computer to execute the dynamic comment display method described in any of the above embodiments.

The computer-readable medium of this embodiment includes permanent and non-permanent, removable and non-removable media, and information storage can be implemented by any method or technology. Information can be computer-readable instructions, data structures, modules of programs, or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, read-only compact disk read-only memory (CD-ROM), digital versatile disk (DVD) or other optical storage, magnetic cassettes, magnetic tape magnetic disk storage or other magnetic storage devices or any other non-transmission media that can be used to store information that can be accessed by a computing device.

The computer instructions stored in the storage medium of the above embodiment are used to enable the computer to execute the dynamic comment display method described in any of the above embodiments, and have the beneficial effects of the corresponding method embodiments, which will not be repeated here.

Based on the same technical concept, the present disclosure also provides a computer program product, including a computer program, which, when executed by a processor, implements the corresponding dynamic comment display method in any of the aforementioned embodiments.

The method of the embodiment of the present application can be implemented in whole or in part in the form of a computer program product. The computer program product includes one or more computer instructions. When the computer program instructions are loaded and executed on a computer, the process or function described in the embodiment of the present application is implemented in whole or in part.

The computer program product of the above embodiment is used to enable the computer to execute the data processing method described in any of the above embodiments, and has the beneficial effects of the corresponding method embodiments, which will not be repeated here.

It should be understood by those skilled in the art that the discussion of any of the above embodiments is merely illustrative and is not intended to imply that the scope of the present disclosure (including the claims) is limited to these examples; based on the concept of the present disclosure, the technical features in the above embodiments or different embodiments may be combined, the steps may be implemented in any order, and there are many other variations of different aspects of the embodiments of the present disclosure as described above, which are not provided in detail for the sake of simplicity.

In addition, to simplify the description and discussion, and in order not to obscure the embodiments of the present disclosure, known power/ground connections to integrated circuit (IC) chips and other components may or may not be shown in the provided figures. In addition, devices may be shown in the form of block diagrams to avoid obscuring the embodiments of the present disclosure, and this also takes into account the fact that the details of the implementation of these block diagram devices are highly dependent on the platform on which the embodiments of the present disclosure are to be implemented (i.e., these details should be fully within the scope of understanding of those skilled in the art). Where specific details (e.g., circuits) are set forth to describe exemplary embodiments of the present disclosure, it is apparent to those skilled in the art that the embodiments of the present disclosure may be implemented without these specific details or with variations in these specific details. Therefore, these descriptions should be considered illustrative rather than restrictive.

Although the present disclosure has been described in conjunction with specific embodiments of the present disclosure, many alternatives, modifications and variations of these embodiments will be apparent to those skilled in the art from the foregoing description. For example, other memory architectures (e.g., dynamic RAM (DRAM)) may use the discussed embodiments.

The embodiments of the present disclosure are intended to cover all such substitutions, modifications and variations that fall within the broad scope of the appended claims. Therefore, any omissions, modifications, equivalent substitutions, improvements, etc. made within the spirit and principles of the embodiments of the present disclosure should be included in the scope of protection of the present disclosure.

1. A dynamic comment display method includes:
determining a first dynamic comment to be displayed in a dynamic comment display area;
matching a first trajectory with the first dynamic comment, wherein the dynamic comment display area includes a plurality of trajectories for defining moving tracks of dynamic comments, the plurality of trajectories for defining the moving tracks of the dynamic comments include the first trajectory, and the plurality of trajectories are distributed radially; and
displaying the first dynamic comment moving along the first trajectory.

2. The dynamic comment display method according to claim 1, wherein matching the first trajectory with the first dynamic comment comprises:
obtaining a second trajectory used when displaying a second dynamic comment, the second dynamic comment being the previous dynamic comment of the first dynamic comment; and
matching the first trajectory from other trajectories except the second trajectory.

3. The dynamic comment display method according to claim 1, wherein matching the first trajectory with the first dynamic comment comprises:
obtaining a second trajectory used when displaying a second dynamic comment, the second dynamic comment being the previous dynamic comment of the first dynamic comment; and
matching the first trajectory from trajectories whose angle with the second trajectory is greater than a first threshold.

4. The dynamic comment display method according to claim 1, wherein matching the first trajectory with the first dynamic comment comprises:
obtaining a cumulative number of usage times for each trajectory; and
matching the first trajectory from trajectories with the least cumulative number of usage times.

5. The dynamic comment display method according to claim 1, wherein matching the first trajectory with the first dynamic comment comprises:
obtaining a number of co-occurring dynamic comments in each trajectory, wherein the number of co-occurring dynamic comments is a number of dynamic comments currently displayed on the trajectory; and
matching the first trajectory from trajectories with the least number of co-occurring dynamic comments.

6. The dynamic comment display method according to claim 1, wherein displaying the first dynamic comment moving along the first trajectory comprises:
detecting a number of co-occurring dynamic comments in the first trajectory, wherein the number of co-occurring dynamic comments is a number of dynamic comments currently displayed on the first trajectory; and
in response that the number of the co-occurring dynamic comments is greater than a second threshold, increasing a moving speed of the first dynamic comment.

7. The dynamic comment display method according to claim 1, wherein displaying the first dynamic comment moving along the first trajectory comprises:
moving the first dynamic comment along the first trajectory, and
during a process of moving the first dynamic comment, changing at least one of the following parameters of the first dynamic comment gradually:
size;
transparency; and
the offset value within the trajectory.

8. The dynamic comment display method according to claim 1, wherein displaying the first dynamic comment moving along the first trajectory comprises:
moving the first dynamic comment along the first trajectory;
in response that the first dynamic comment contacts the edge of the dynamic comment display area, adjusting a moving direction of the first dynamic comment to be perpendicular to the edge of the dynamic comment display area.

9. The dynamic comment display method according to claim 1, wherein the method further comprises:
feathering upper and lower edges of the dynamic comment display area.

10. (canceled)

11. An electronic device, comprising a memory, a processor, and a computer program stored in the memory and executable on the processor, wherein the computer program, when executed by the processor, causes the processor to:
determine a first dynamic comment to be displayed in a dynamic comment display area;
match a first trajectory with the first dynamic comment, wherein the dynamic comment display area includes a plurality of trajectories for defining moving tracks of dynamic comments, the plurality of trajectories for defining the moving tracks of the dynamic comments include the first trajectory, and each trajectory starts from a center of the dynamic comment display area, radiates outward, and extends to an edge of the dynamic comment display area; and
display the first dynamic comment moving along the first trajectory.

12. A non-transitory computer-readable storage medium, wherein the non-transitory computer-readable storage medium stores computer instructions, and the computer instructions are configured to cause a computer to:
determine a first dynamic comment to be displayed in a dynamic comment display area;
match a first trajectory with the first dynamic comment, wherein the dynamic comment display area includes a plurality of trajectories for defining moving tracks of dynamic comments, the plurality of trajectories for defining the moving tracks of the dynamic comments include the first trajectory, and each trajectory starts from a center of the dynamic comment display area, radiates outward, and extends to an edge of the dynamic comment display area; and
display the first dynamic comment moving along the first trajectory.

13. (canceled)

14. The dynamic comment display method according to claim 1, wherein each trajectory of the plurality of trajectories starts from a center of the dynamic comment display area, radiates outward, and extends to an edge of the dynamic comment display area.

15. The electronic device of claim 11, wherein the computer program causing the processor to match the first trajectory with the first dynamic comment comprises instructions to:
obtain a second trajectory used when displaying a second dynamic comment, the second dynamic comment being the previous dynamic comment of the first dynamic comment; and
match the first trajectory from other trajectories except the second trajectory.

16. The electronic device of claim 11, wherein the computer program causing the processor to match the first trajectory with the first dynamic comment comprises instructions to:
obtain a second trajectory used when displaying a second dynamic comment, the second dynamic comment being the previous dynamic comment of the first dynamic comment; and
match the first trajectory from trajectories whose angle with the second trajectory is greater than a first threshold.

17. The electronic device of claim 11, wherein the computer program causing the processor to match the first trajectory with the first dynamic comment comprises instructions to:
obtain a cumulative number of usage times for each trajectory; and
match the first trajectory from trajectories with the least cumulative number of usage times.

18. The electronic device of claim 11, wherein the computer program causing the processor to match the first trajectory with the first dynamic comment comprises instructions to:
obtain a number of co-occurring dynamic comments in each trajectory, wherein the number of co-occurring dynamic comments is a number of dynamic comments currently displayed on the trajectory; and
match the first trajectory from trajectories with the least number of co-occurring dynamic comments.

19. The electronic device of claim 11, wherein the computer program causing the processor to display the first dynamic comment moving along the first trajectory comprises instructions to:
detect a number of co-occurring dynamic comments in the first trajectory, wherein the number of co-occurring dynamic comments is a number of dynamic comments currently displayed on the first trajectory; and
in response that the number of the co-occurring dynamic comments is greater than a second threshold, increase a moving speed of the first dynamic comment.

20. The electronic device of claim 11, wherein the computer program causing the processor to display the first dynamic comment moving along the first trajectory comprises instructions to:
move the first dynamic comment along the first trajectory, and
during a process of moving the first dynamic comment, change at least one of the following parameters of the first dynamic comment gradually:
size;
transparency; and
the offset value within the trajectory.

21. The electronic device of claim 11, wherein the computer program causing the processor to display the first dynamic comment moving along the first trajectory comprises instructions to:
move the first dynamic comment along the first trajectory;
in response that the first dynamic comment contacts the edge of the dynamic comment display area, adjust a moving direction of the first dynamic comment to be perpendicular to the edge of the dynamic comment display area.

22. The electronic device of claim 11, the computer program further comprises instructions to:
feather upper and lower edges of the dynamic comment display area.
